(19) United States
(12) Patent Application Publication
(10) Pub. No.: US 2005/0168767 A1
(43) Pub. Date: Aug. 4, 2005

(54) Method and system for reprinting pages

(75) Inventors: Brian W. Moroney, Longmont, CO (US); Ronald E. Van Buskirk II, Nederland, CO (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/770,250

(22) Filed: Feb. 2, 2004

(51) Int. Cl. G06F 3/12

(52) U.S. Cl. 358/1.14

(57) ABSTRACT

A method and system for reprinting a portion of at least one document is disclosed. The document(s) include a plurality of pages. The method and system include querying a user regarding the portion of the document(s) that includes at least one erroneous page. The method and system also include instructing the user on loading at least a remaining portion of the document(s) or receiving an indication from the user as to how at least the remaining portion of the document(s) are loaded. The method and system also include automatically reprinting the portion of the document(s) to provide at least one reprinted page that is to replace the erroneous page(s). The method and system also include automatically merging the at least one reprinted page with the remaining portion of the document(s).

### FIELD OF THE INVENTION

The present invention relates to printing systems, and more particularly to a method and system for providing an improved method for reprinting portions of documents.

### BACKGROUND OF THE INVENTION

Currently, printing shops are used to print a variety of at least one document. For example, one popular use of printing shops is in high volume printing, particularly of at least one document that contains a large number of pages. For example, an instructor may request hundred of copies of a teaching document that may be tens or hundreds of pages long. Once the copies of the document are printed, it may be determined that one or more pages in the document are erroneous. As used herein, an erroneous page is a page that requires reprinting for some reason. For example, the page may contain errors or the author of the document may simply desire a change on the erroneous page. The printing shop must then determine how to provide a user with an updated document having the erroneous pages corrected.

FIG. 1 is a diagram of a conventional method 10 for reprinting a portion of a document. The method 10 is used to address the problem of a document having one or more erroneous pages. It is determined whether only a portion of the document is to be reprinted or whether the entire document is to be reprinted, via step 12. It may be desirable to reprint the entire document if the cost, including supplies and manpower, of reprinting the erroneous pages only is too high. In addition, if the errors on the pages change the pagination of the document, it may be decided to reprint the entire document. If it is determined that the entire document is to be reprinted, then the document having the erroneous pages is discarded, via step 14. The entire document is then reprinted, via step 16. Thus, a completely new updated document is provided in step 16.

If only a portion of the document is to be reprinted, then selected pages are reprinted, via step 18. Step 18 may be accomplished using conventional job ticketing, in which the user indicates on a ticket the pages that are to be replaced. Typically, only the erroneous pages are reprinted. The reprinted pages are then inserted into each copy of the document, via step 20. Typically, step 20 is performed manually. Thus, an individual must properly insert each of the pages into each copy in step 20. The old version of the pages that were reprinted is also discarded, via step 20.

Although the conventional method 10 functions, one of ordinary skill in the art will readily recognize that the conventional method is extremely wasteful. If the entire document is reprinted in step 16, then a number of pages which were not erroneous may be discarded in step 14. For a document having a large number of pages and/or for which a large number of copies is printer, the paper waste may be quite high. On the other hand, if only the erroneous pages are reprinted in step 20, then the labor cost of inserting the pages into the appropriate location(s) in the document(s) may also be very high. Thus, either option can cost the printing shop a great deal in time, money, and other resources.

Accordingly, what is needed is a system and method for improving the reprinting of documents. The present invention addresses such a need.

### SUMMARY OF THE INVENTION

The present invention provides a method and system for reprinting a portion of at least one document. The document(s) include a plurality of pages. The method and system comprise querying a user regarding the portion of the document(s) that includes at least one erroneous page. In a preferred embodiment, the method and system may also alert the user to certain conditions, such as errors. The method and system also comprise instructing the user on loading at least a remaining portion of the document(s) or receiving an indication from the user as to how at least the remaining portion of the document(s) are loaded. The method and system also comprise automatically reprinting the portion of the document(s) to provide at least one reprinted page that is to replace the erroneous page(s). The method and system also comprise automatically merging the at least one reprinted page with the remaining portion of the document(s).

According to the system and method disclosed herein, the present invention provides a method and system for reprinting portions of at least one document in a manner that is more efficient, resulting in less paper waste without requiring an undue amount of time

### BRIEF DESCRIPTION OF THE DRAWINGS

FIG. 1 is a diagram of a conventional method for reprinting a portion of at least one document.

FIG. 2 is a high-level flow chart depicting one embodiment of a method in accordance with the present invention for reprinting a portion of at least one document.

FIG. 3 is a high-level block diagram depicting one embodiment of a system in accordance with the present invention for reprinting a portion of at least one document.

FIG. 4 is a more detailed flow chart depicting one embodiment of a method in accordance with the present invention for reprinting a portion of at least one document.

FIG. 5 is a high-level flow chart depicting one embodiment of a method in accordance with the present invention for addressing errors in reprinting a portion of at least one document.

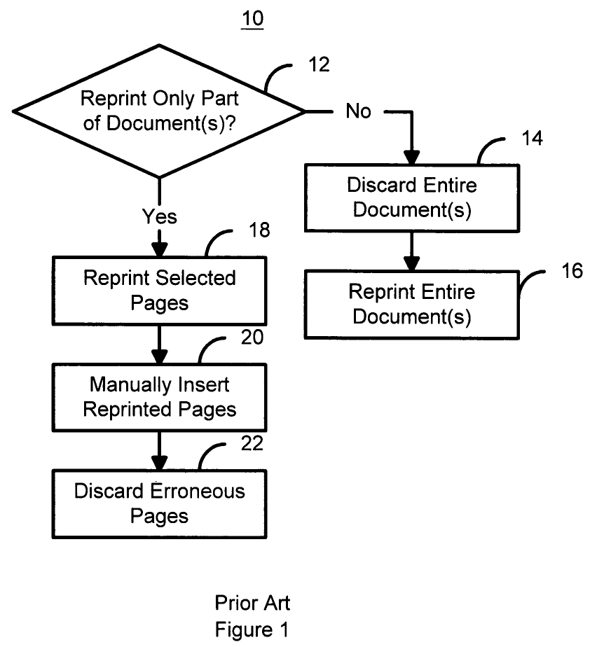

### DETAILED DESCRIPTION OF THE INVENTION

The present invention relates to an improvement in printing of at least one document. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for reprinting a portion of at least one document. The document(s) include a plurality of pages. The method and system comprise querying a user regarding the portion of the document(s) that includes at least one erroneous page. The method and system also comprise instructing the user on loading at least a remaining portion of the document(s) or receiving an indication from the user as to how at least the remaining portion of the document(s) are loaded. The method and system also comprise automatically reprinting the portion of the document(s) to provide at least one reprinted page that is to replace the erroneous page(s). The method and system also comprise automatically merging the at least one reprinted page with the remaining portion of the document(s).

The present invention will be described in terms of a particular system having particular components as well as certain methods. However, one of ordinary skill in the art will readily recognize that this method and system will operate effectively for other systems having other and/or different components as well as other methods having other and/or different steps not inconsistent with the present invention. The present invention will also be described in the context of print shops. However, one of ordinary skill in the art will readily recognize that the method and system operate effectively in other environments.

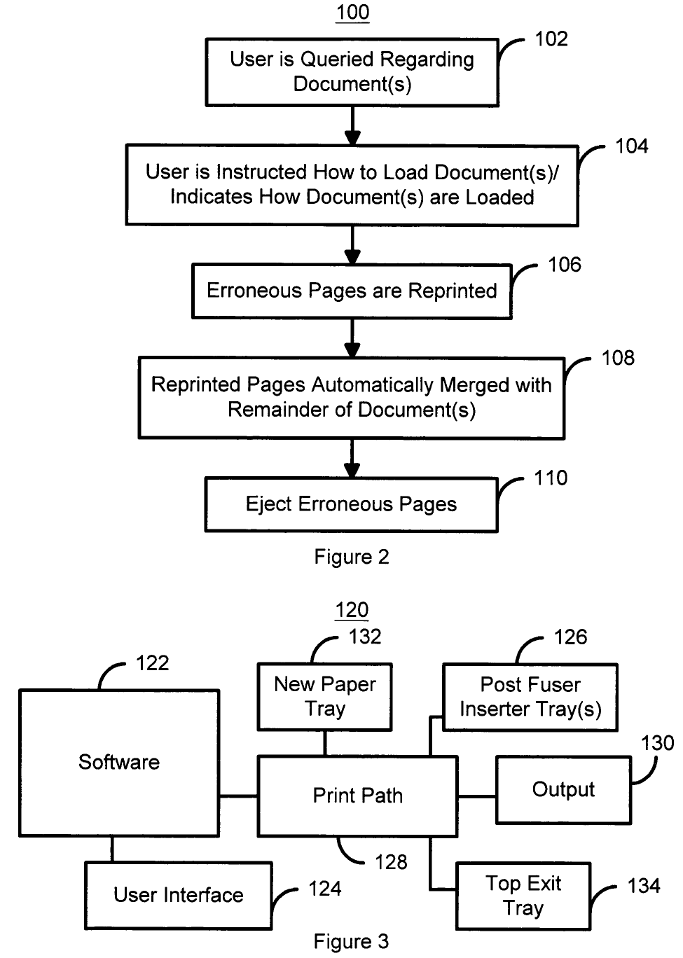

To more particularly illustrate the method and system in accordance with the present invention, refer now to FIG. 2, depicting a high-level flow chart of one embodiment of a method 100 in accordance with the present invention for reprinting a portion of at least one document. FIG. 3 is a high-level block diagram depicting one embodiment of a system 120 in accordance with the present invention for reprinting a portion of at least one document. The method 100 is preferably performed using the system 120. Consequently, the method 100 is described in the context of the system 120. However, nothing prevents the use of another system for reprinting a document.

Referring to FIGS. 2 and 3, the system 120 includes software 122, a user interface 124, a print path 128, and an output 130. The system 120 also preferably includes at least one post fuser inserter tray 126, a new paper tray 132, and a top exit tray 134. The user is queried regarding the document(s) being reprinted, via step 102. In a preferred embodiment, the software 122 queries the user via the user interface 124, for example by providing a text message. The user might be queried as to whether old and new copies of the document are available, what other features the user would desire to use, whether certain pagination changes, the number of copies desired, or other information. In a preferred embodiment, the user might also be alerted to certain conditions such as paper jams or other errors.

The user is instructed as to how to load the copy or copies of the document that are to be reprinted, via step 104. In a preferred embodiment, the user is instructed to load the entire document being reprinted into one or more of the post fuser inserter tray(s) 126. In an alternate embodiment, the user is instructed to load only those pages that are not being reprinted. As a result, the pages of the document that are already printed and which are not being replaced will not go through the portion of the print path 128 that actually prints a page. In a preferred embodiment, the print path 128 prints to a page by heating toner to affix toner to the page in the desired locations. If an already printed page is heated in such a manner, the characters already printed may melt, rendering the page unusable and causing damage to or dirtying the print path 128. The post fuser inserter tray 126 is used as a source of paper which will not pass through this portion of the print path 128. The new paper tray 132 is used for paper which will be printed. Consequently, only the page(s) that are being reprinted to replace the erroneous pages will pass through this portion of the print path. Consequently, damage to the system 120 is avoided.

The erroneous pages are reprinted, via step 106. Step 106 is preferably performed by sending new paper through the print path 128 and printing to the paper. The new, reprinted pages are merged with the remainder of the document, via step 108. In a preferred embodiment, step 108 is accomplished by the system 120 providing both reprinted pages from the new paper tray 132 and the print path 128 and already printed pages from the post fuser inserter tray 126 in the appropriate order to the output 130. In addition, if the entire document was loaded by the user, then step 130 may include discarding the erroneous pages from the old document(s). The erroneous pages may then be ejected, via step 110. Preferably, the erroneous pages would be ejected into the top exit tray 134.

Thus, the document(s) output using the method 100 and system 120 has both old and reprinted pages in the proper order and does not include erroneous pages. Because the user is queried and instructed how to load the document(s) in steps 102 and 104, the method 100 and system 120 are simpler to use. Furthermore, because the user need not manually insert the reprinted pages, a significant amount of labor may be saved. Because the entire document is not discarded then reprinted, paper waste may also be substantially reduced.

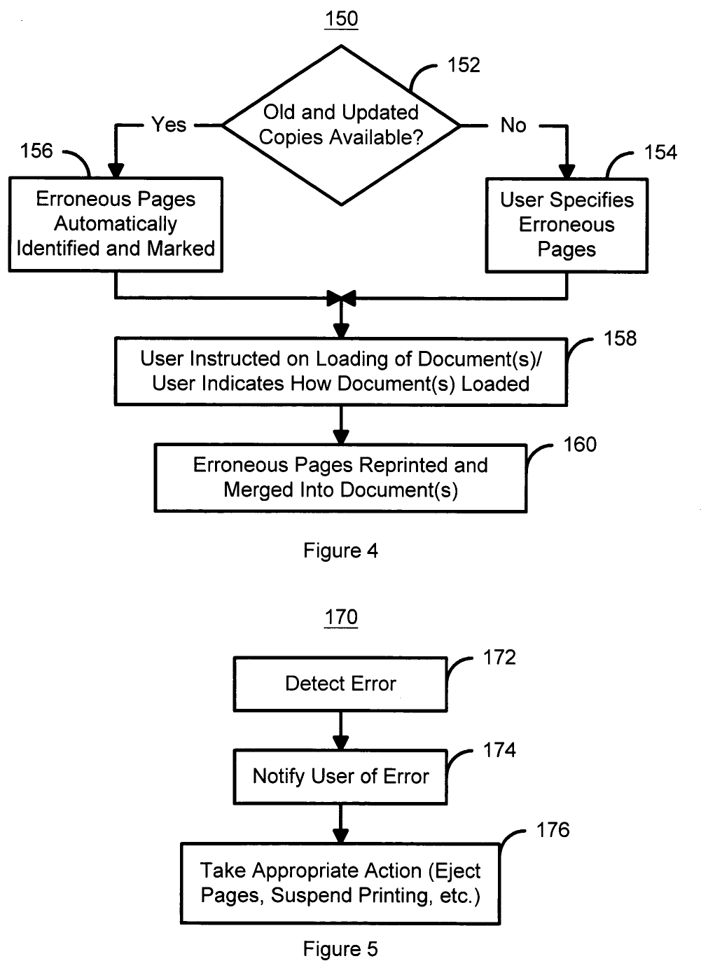

FIG. 4 is a more detailed flow chart depicting one embodiment of a method 150 in accordance with the present invention for reprinting a portion of at least one document. The method 150 is thus preferably used to perform the method 100 depicted in FIG. 2. The method 150 is preferably performed using the system 120. Consequently, the method 150 is described in the context of the system 120. However, nothing prevents the use of another system for reprinting a document.

Referring to FIGS. 3 and 4, it is determined whether an old copy containing erroneous pages and an updated copy containing corrected pages replacing the erroneous pages are available, via step 152. Step 152 is preferably performed by querying the user using the software 122. In one embodiment, the copies are soft copies. However, in another embodiment, the copies may be hard copies. In another embodiment, the copies may be hard copies or soft copies. If both the old and updated copies are not available, then the erroneous pages are specified, via step 154. In a preferred embodiment, the software 122 queries the user regarding the erroneous pages in step 154. However, other mechanisms might also be used. Also in a preferred embodiment, the user enters the length of the document in step 154. In one embodiment, it is assumed that the documents have the same length if the user does not indicate a length in step 154. If both copies of the document(s) are available, then the erroneous pages are automatically identified, via step 156. In a preferred embodiment, step 156 is performed by the software 122 comparing the old and updated copies of the document(s) and identifying the page(s) that are different. Step 156 also preferably includes marking those pages that are different and which will be replaced.

The user is instructed to load the document(s) in the appropriate location(s), via step 158. In a preferred embodiment, the user is instructed to load the entire document being reprinted. In an alternate embodiment, the user is instructed to load only those pages that are not being reprinted. The manner in which the document is to be loaded is also preferably indicated in step 158. For example, the user may be told to load the pages face up or face down. Preferably, the user is instructed to use the post fuser inserter tray 126. As a result, the pages of the document that are already printed and which are not being replaced will not go through the portion of the print path 128 that actually prints a page. In an alternate embodiment, in step 158 the user instructs the software as to how the document is loaded.

The erroneous pages that are being replaced are reprinted and merged with the remainder of the document(s), via step 160. In a preferred embodiment, if a current page is a reprinted page used to replace an erroneous page, then the system 120 takes a page from the new paper tray 132 and prints it using the print path 128, then outputs the page. Also in a preferred embodiment, the erroneous page is discarded, preferably by ejecting the page into the top exit tray 134. If the current page is not an erroneous page, then the system 120 takes the page from the post fuser inserter tray 126 and provides the page to the output 130. Thus, the pages for the document(s) being reprinted are output in the desired order. Thus, the updated document output by the system 120 using the method 150 includes old, correct pages and reprinted pages in the appropriate order. In one embodiment, if the pagination has changed more pages will be reprinted using the method 150 in order to obtain the correct page numbers. In an alternate embodiment, page numbers may not be printed. Instead the page numbers may be inserted after it is determined that the document will not be reprinted again.

Thus, the document(s) output using the method 150 and system 120 has both old and reprinted pages in the proper order and does not include erroneous pages. Because the user is queried and instructed how to load the document(s) or instructs the system 120 as to how the document(s) are loaded in steps 152 and 158, the method 150 and system 120 are simpler to use. Furthermore, because the user need not manually insert the reprinted pages, a significant amount of labor may be saved. Because the entire document is not discarded then reprinted, paper waste may also be substantially reduced.

FIG. 5 is a high-level flow chart depicting one embodiment of a method 170 in accordance with the present invention for addressing errors in reprinting a portion of at least one document. The method 170 is preferably performed using the system 120. Consequently, the method 170 is described in the context of the system 120. However, nothing prevents the use of another system for reprinting a document. The method 170 preferably runs in parallel with the method 100 and/or 150. Thus, the method 170 allows errors to be addressed during reprinting using the method 100 and/or 150.

Referring to FIGS. 3 and 4, the error is detected, via step 172. For example, step 172 might include determining that a paper jam exists or that the new paper tray 132 is empty. The user is notified of the error, via step 174. Thus, the user may have an opportunity to correct the error. The system 120 then takes the appropriate action, via step 176. In some cases, the system 120 may then eject the remaining pages in step 176. In a preferred embodiment, the system 120 only ejects the remaining pages for certain errors. For example, an empty new paper tray may suspend the reprinting of the document using the method 100 or 150 until more paper is added. Printing may then recommence. However, other errors such as a paper jam may cause the reprinting to be aborted and the remaining pages to be ejected in step 176.

A method and system has been disclosed for more efficiently reprinting a portion of at least one document. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for reprinting a portion of at least one document, the at least one document including a plurality of pages comprising:
(a) querying a user regarding the portion of the at least one document, the portion of the at least one document including at least one erroneous page;
(b) instructing the user on loading at least a remaining portion of the at least one document;
(c) automatically reprinting the portion of the at least one document to provide at 10 least one reprinted page for replacing the at least one erroneous page; and
(d) automatically merging the at least one reprinted page with the remaining portion of the at least one document.

2. The method of claim 1 wherein the querying step (a) further includes the step is of:
(a1) querying the user as to whether an updated copy of the at least one document is available.

3. The method of claim 2 further comprising:
(e) if the updated copy of the at least one document is available, automatically identifying the at least one erroneous page;
(f) if the updated copy of the at least one document is not available, allowing the user to identify the at least one erroneous page.

4. The method of claim 3 further comprising:
(g) determining whether at least one error exists; and
(h) notifying the user of the at least one error.

5. The method of claim 4 further comprising:
(i) ejecting a portion of the remaining portion of the at least one document.

6. The method of claim 4 wherein the at least one error includes a printer jam.

7. A method for reprinting a portion of at least one document, the at least one document including a plurality of pages comprising:
(a) querying a user regarding the portion of the at least one document, the portion of the at least one document including at least one erroneous page;
(b) allowing the user to specify how at least a remaining portion of the at least one document is loaded;
(c) automatically reprinting the portion of the at least one document to provide at least one reprinted page for replacing the at least one erroneous page; and
(d) automatically merging the at least one reprinted page with the remaining portion of the at least one document.

8. A system for reprinting a portion of at least one document, the at least one document including a plurality of pages, the system comprising:
software for querying a user regarding the portion of the at least one document, the portion of the at least one document including at least one erroneous page, instructing the user on loading at least a remaining portion of the at least one document, and controlling the automatic reprinting the portion of the at least one document to provide at least one reprinted page for replacing the at least one erroneous page; and
a printer for automatically reprinting the at least one erroneous page; and
a tray for automatically merging the at least one reprinted page with the remaining portion of the at least one document.

9. The system of claim 8 wherein the software further queries the user as to whether an updated copy of the at least one document is available.

10. The system of claim 9 wherein the software further automatically identifies the at least one erroneous page if the updated copy of the at least one document is available and allows the user to identify the at least one erroneous page if the updated copy of the at least one document is not available.

11. The system of claim 10 wherein the software further determines whether at least one error exists and notifies the user of the at least one error.

12. The system of claim 11 wherein the at least one error includes a printer jam.

13. The system of claim 11 further comprising:
a post fuser inserter for retaining the remaining portion of the at least one document loaded by the user.

14. A system for reprinting a portion of at least one document, the at least one document including a plurality of pages, the system comprising:
software for querying a user regarding the portion of the at least one document, the portion of the at least one document including at least one erroneous page, receives an indication from the user as to how the at least the remaining portion of the at least one document is loaded, and controlling the automatic reprinting the portion of the at least one document to provide at least one reprinted page for replacing the at least one erroneous page; and
a printer for automatically reprinting the at least one erroneous page; and
a tray for automatically merging the at least one reprinted page with the remaining portion of the at least one document.
